(19) United States
(12) Patent Application Publication
(10) Pub. No.: US 2014/0344179 A1
(43) Pub. Date: Nov. 20, 2014

(54) AUTOMATED SUPPLIER MANAGEMENT PROCESSES

(71) Applicant: ORACLE INTERNATIONAL CORPORATION, Redwood Shores, CA (US)

(72) Inventors: Jeffrey Richard Glanville, Menlo Park, CA (US); Hong Gao, Santa Clara, CA (US); Karthikkrishnan Natarajan, Tamilnadu (IN); Sriram Parameswaran, Hyderabad (IN); Sonal Keshav Hede, Redwood City, CA (US); Reza Widjaja, San Mateo, CA (US); Shan Gao, Sunnyvale, CA (US); Udaykumar Kottamasu, Hyderabad (IN); Marc Fermin Cagigas, Castro Valley, CA (US)

(73) Assignee: ORACLE INTERNATIONAL CORPORATION, Redwood Shores, CA (US)

(21) Appl. No.: 13/896,286

(22) Filed: May 16, 2013

(51) Int. Cl. G06Q 10/08

(52) U.S. Cl. CPC G06Q 10/083
USPC 705/330

(57) ABSTRACT

Systems and methods provide for supplier information handling. A trigger event corresponding to a requested change in a supplier relationship status for a prospective supplier may be recognized. Responsive to the trigger event, a supplier profile corresponding to the prospective supplier may be processed to identify missing profile information. A workflow may be launched to collect the missing profile information from the prospective supplier. The missing profile information may be collected from the prospective supplier. Responsive to an approval of changes to the supplier profile based on the missing profile information, a spend authorization workflow may be launched to promote the supplier relationship status.

### BACKGROUND

Certain embodiments of the present disclosure relate generally to sourcing, procurement, and supplier management, and in particular to automated supplier management processes.

There is significant time spent by companies gathering all the required information from new suppliers needed for doing business. The extensive supplier data that companies require before any contracts or orders can be initiated oftentimes is extensive and may include information about locations, contacts, diversity classifications, preferred payment methods, bank account information, tax identifications, etc. Conventional procurement approaches do not adequately address collaboration between buyer and supplier for capturing all the supplier's organization information at the point of initiating a business relationship to conduct commerce. For example, conventional approaches to sourcing, procurement, or supplier management may rely on manual intervention by users to collect missing supplier data.

Accordingly, it would desirable to have techniques to enhance supplier management.

### BRIEF SUMMARY

Certain embodiments of the present disclosure relate generally to sourcing, procurement, and supplier management, and in particular to automated supplier management processes.

In one aspect, a non-transitory computer-readable storage medium having stored thereon instructions for facilitating a supplier information handling system is provided. The instructions, when executed by one or more processors, may cause the one or more processors to perform one or more of the following. A trigger event corresponding to a requested change in a supplier relationship status for a prospective supplier may be recognized. Responsive to the trigger event, a supplier profile corresponding to the prospective supplier may be processed to identify missing profile information. A workflow may be launched to collect the missing profile information from the prospective supplier. The missing profile information may be collected from the prospective supplier. Responsive to an approval of changes to the supplier profile based on the missing profile information, a spend authorization workflow may be launched to promote the supplier relationship status.

In another aspect, a method for supplier relationship management is provided. The method may include one or more of the following. A trigger event corresponding to a requested change in a supplier relationship status for a prospective supplier may be recognized. Responsive to the trigger event, a supplier profile corresponding to the prospective supplier may be processed to identify missing profile information. A workflow may be launched to collect the missing profile information from the prospective supplier. The missing profile information may be collected from the prospective supplier. Responsive to an approval of changes to the supplier profile based on the missing profile information, a spend authorization workflow may be launched to promote the supplier relationship status.

In yet another aspect, supplier relationship management system is provided. The supplier relationship management system may include one or more network interfaces configured to provide access to a network. One or more processors may be coupled to the one or more network interfaces to execute instructions to perform one or more of the following. A trigger event corresponding to a requested change in a supplier relationship status for a prospective supplier may be recognized. Responsive to the trigger event, a supplier profile corresponding to the prospective supplier may be processed to identify missing profile information. A workflow may be launched to collect the missing profile information from the prospective supplier. The missing profile information may be collected from the prospective supplier. Responsive to an approval of changes to the supplier profile based on the missing profile information, a spend authorization workflow may be launched to promote the supplier relationship status. The supplier relationship management system may include one or more storage media coupled to the one or more processors to retain the instructions.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a high-level block diagram of a system, in accordance with certain embodiments of the present disclosure.

FIG. 2 is a high-level block diagram of one example of the supplier information handling system, in accordance with certain embodiments of the present disclosure.

FIG. 3 is a block diagram that illustrates certain aspects of a supplier management lifecycle, in accordance with certain embodiments of the present disclosure.

FIGS. 4A, 4B, and 4C illustrate an example flow diagram for a process corresponding to certain aspects of a supplier management lifecycle, in accordance with certain embodiments of the present disclosure.

FIG. 5 is a screenshot illustrating an example user interface for configuring supplier registration and self-service profile management, in accordance with certain embodiments of the present disclosure.

FIG. 6 is a screenshot illustrating an example supplier side user notification for notifying a supplier side user regarding completion of a supplier profile, in accordance with certain embodiments of the present disclosure.

FIGS. 7A and 7B are screenshots illustrating an example user interface for a supplier side user to view and update a supplier profile, in accordance with certain embodiments of the present disclosure.

FIG. 8 is a screenshot illustrating an example user interface to facilitate management of suppliers, in accordance with certain embodiments of the present disclosure.

FIG. 9 is a screenshot illustrating an example user interface to facilitate supplier profile change request approval, in accordance with certain embodiments of the present disclosure.

FIG. 10 is a screenshot illustrating an example user interface to facilitate approval of a supplier for spend, in accordance with certain embodiments of the present disclosure.

FIG. 11 is a business relationship state transition diagram, in accordance with certain embodiments of the present disclosure.

FIG. 12 is a diagram of an exemplary environment with which embodiments may be implemented, in accordance with certain embodiments of the present disclosure.

FIG. 13 is a diagram of an embodiment of a special-purpose computer system, in accordance with certain embodiments of the present disclosure.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Certain embodiments according to the present disclosure may provide for enhanced procurement product solutions including one or more of sourcing, purchasing, and/or supplier management products solutions. Supplier management is becoming increasingly important. As customers achieve greater process savings and cost savings out of procurement activities, supplier aspects may be a high priority target for improved management to achieve greater process and cost savings. Qualifying suppliers, managing compliance, and assessing supplier risk may depend on a supplier profile. Before a sourcing award flow can finish, a complete supplier profile may be required to execute downstream purchase order and invoice processing, as well as for managing the long-term relationship with the supplier. Typically, this work may be left to supplier management functions responsible for completing supplier setup and ensuring all details about the supplier are defined and ready for order execution. The buying organization may contact a supplier and may enter the collected information into a procurement system before ordering can commence with the supplier. Sourcing solutions may require only a minimum amount of information from prospective suppliers to participate in RFQs (request for quotes) or competitive bid opportunities, so most of the detailed organizational information needed to execute orders, payments, tax reporting, etc., may not be needed until a later stage. However, with certain embodiments according to the present disclosure, supplier data collection is automated for the buying organization so as to provide visibility of requested changes. Certain embodiments may provide process integration back to the sourcing award flow to complete and initiate purchasing document execution.

Certain embodiments may facilitate collaboration with suppliers and may allow suppliers to log on and access information about procurement-related transactions, agreements, orders, invoices, payments, and/or the like. This may provide visibility for a supplier and allow interaction with procure-to-pay processes, such as requesting changes to orders if demand cannot be met or orders cannot be fulfilled, inputting invoices electronically into the system, etc. And certain embodiments may help suppliers to engage in self-management of profile information, and may facilitate profile reviews and updates on a timely basis.

Suppliers may be empowered to maintain their own profiles associated with a supplier information handling system and may be provided with a number of features to manage profile change processes. The supplier management processes may be streamlined with active and efficient involvement from suppliers. Further benefits resulting from embodiments according to the present disclosure may include improved accuracy of supplier profile information, reduced costs associated with profile management, and increased communication with suppliers on profile review and updates. Certain embodiments may further allow configuration of supplier profile elements to be change-controlled, supplier-initiated profile changes to be reviewed and approved by internal users, and may support notifications to suppliers regarding profile review, profile updates, and the like. Certain embodiments may provide for a spend authorization review process, which a buying organization may use to ensure that supplier profile is accurate and complete before executing a business transaction with the supplier.

Certain embodiments may include a web-based procurement tool that is deployable to multiple users associated with an enterprise. Certain embodiments may include a supplier portal. The supplier portal may allow a supplier to manage the supplier's profile information. In some embodiments, the supplier portal may be implemented with an application that, for example, may be part of a suite of applications, such as a procurement suite that may help automate and manage procurement.

Certain embodiments may provide for supplier management process automation that facilitates the collection of company profile information from an external party (e.g., a prospective supplier). Company profile information may be collected into an application that, for example, may be employed by a buying organization. Collection processes can be system-initiated based on a sourcing award event or can be initiated by manually promoting the prospective supplier. Certain embodiments may provide for automatically initiating a workflow to a prospective supplier to collect all required company profile information after being awarded business from a competitive bid process. Certain embodiments may provide process automation for getting suppliers “ready” for transaction processing. With such embodiments, manual intervention by users to collect missing supplier data after an award event need not be necessary.

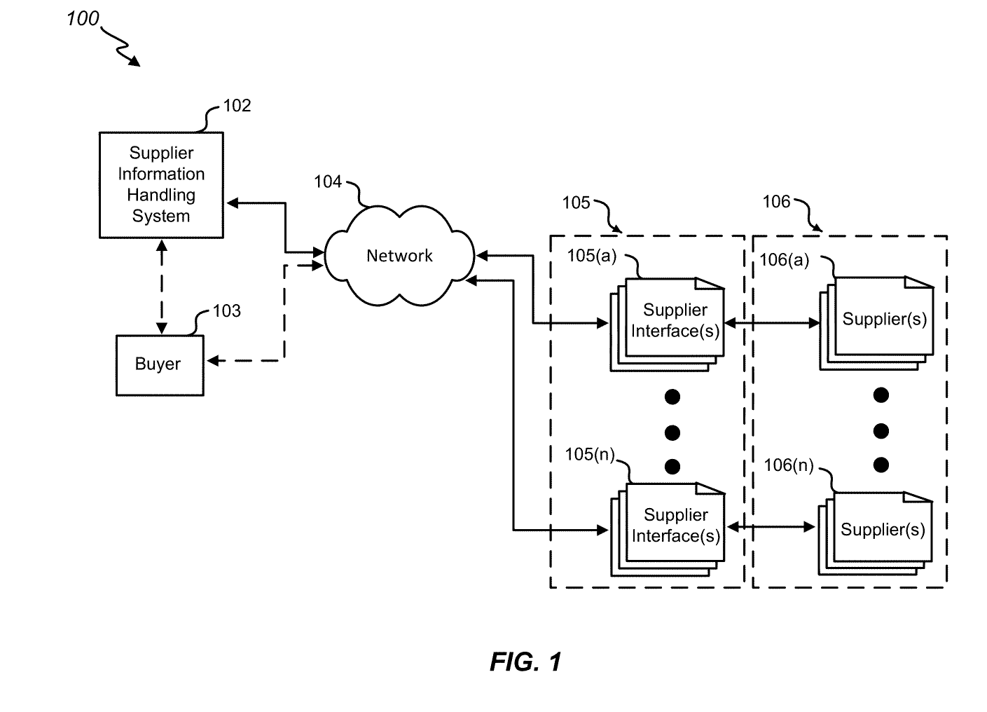

Various embodiments will now be discussed in greater detail with reference to the accompanying figures, beginning with FIG. 1.

FIG. 1 depicts a high-level block diagram of a system 100, in accordance with certain embodiments of the present disclosure. The system 100 allows transfer of information from and/or to a supplier information handling system 102, a buyer 103, and/or one or more suppliers 106. As depicted, the suppliers 106 may be communicatively coupled or couplable to a network 104 through one or more supplier interfaces 105.

The network 104 may be any suitable means to facilitate data transfer in the system 100. In various embodiments, the network 104 may be implemented with, without limitation, one or more of the Internet, a wide area network (WAN), a local area network (LAN), a wireless local area network (WLAN), a metropolitan area network (MAN), a cellular network, such as through 4G, 3G, GSM, etc., another wireless network, a gateway, and/or any other appropriate architecture or system that facilitates the communication of signals, data, and/or message. The network 104 may transmit data using any suitable communication protocol. The network 104 and its various components may be implemented using hardware, software, and communications media such wires, optical fibers, microwaves, radio waves, and other electromagnetic and/or optical carriers, and/or any combination of the foregoing.

The supplier information handling system 102 may be communicatively coupled or couplable to the network 104. In various embodiments, the supplier information handling system 102 may include any device or set of devices configured to compute, process, organize, categorize, qualify, send, receive, retrieve, generate, convey, store, display, present, detect, handle, and/or use any form of information and/or data suitable for embodiments described herein. The supplier information handling system 102 could include a single computing device, a server, for example, or multiple computing devices, which may be implemented in or with a distributed computing and/or cloud computing environment with a plurality of servers and cloud-implemented resources. Thus, the supplier information handling system 102 may include one or more servers. The supplier information handling system 102 may include one or more processing resources communicatively coupled to one or more storage media, random access memory (RAM), read-only memory (ROM), and/or other types of memory. The supplier information handling system 102 may include any one or combination of various input and output (I/O) devices, network ports, and display devices.

In various embodiments, a buyer 103 may be communicatively coupled or couplable to the supplier information handling system 102 directly and/or via the network 104. A buyer 103 may correspond to a buying organization, and the buyer organization may include the supplier information handling system 102 in some embodiments. The buyer(s) 103 and supplier(s) 106 may each include one or more of an individual, an institution, a company, a business, and/or another entity (which may include an agent, representative, and/or associate thereof) that may be interested in doing business and potentially or actually in a business relationship to conduct commerce. In certain embodiments, the buyer(s) 103 and/or supplier(s) 106 may be users of the system 102.

According to certain embodiments, data may be actively gathered and/or pulled from suppliers 106, for example, by accessing a supplier repository. The data pulled and/or pushed from the one or more suppliers 106 may be made available by the supplier information handling system 102 for the buyer 103.

According to certain embodiments, the supplier information handling system 102 may be or include a supplier platform. A supplier 106 may access the supplier information handling system 102 via a supplier interface 105. The supplier interface 105 may allow for transfer of and access to information in accordance with certain embodiments disclosed herein. In various embodiments, the supplier interface(s) 105 may include any suitable input/output module or other system/device operable to serve as an interface between the supplier(s) 105 and the supplier platform. The supplier interface(s) 105 may facilitate communication over the network 104 using any suitable transmission protocol and/or standard. In various embodiments, the supplier information handling system 102 may include, provide, and/or be configured for operation with the supplier interface(s) 105, for example, by making available and/or communicating with one or more of a website, a web page, a web portal, a web application, a mobile application, enterprise software, and/or any suitable application software. In some embodiments, a supplier interface 105 may include an application programming interface (API).

In some embodiments, a supplier interface 105 may include a web interface. The supplier interface 105 may cause a web page to be displayed on a browser of a supplier 105. The web page(s) may display output and receive input from a user (e.g., by using Web-based forms, via hyperlinks, electronic buttons, etc.). A variety of techniques can be used to create the web pages and/or display/receive information, such as JavaScript, Java applications or applets, dynamic HTML and/or AJAX technologies. Accordingly, the supplier information handling system 102 may have web site/portals giving access to such information, such as a supplier portal.

In various embodiments, a supplier interface 105 may include providing one or more display screens that may each include one or more user interface elements. A user interface may include any text, image, and/or device that can be displayed on a display screen for providing information to a user and/or for receiving user input. A user interface may include one or more widgets, text, text boxes, text fields, tables, grids, charts, hyperlinks, buttons, lists, combo boxes, checkboxes, radio buttons, and/or the like.

In certain embodiments, a supplier interface 105 may include a computing device of a supplier 105. In certain embodiments, a supplier interface 105 may include a mobile computing device that may be any portable device suitable for sending and receiving information over a network in accordance with embodiments described herein. For example without limitation, in various embodiments, the computing device may include one or more devices variously referenced as a desktop computer, mobile phone, a cellular telephone, a smartphone, a handheld mobile device, a tablet computer, a web pad, a personal digital assistant (PDA), a notebook computer, a handheld computer, a laptop computer, and/or the like.

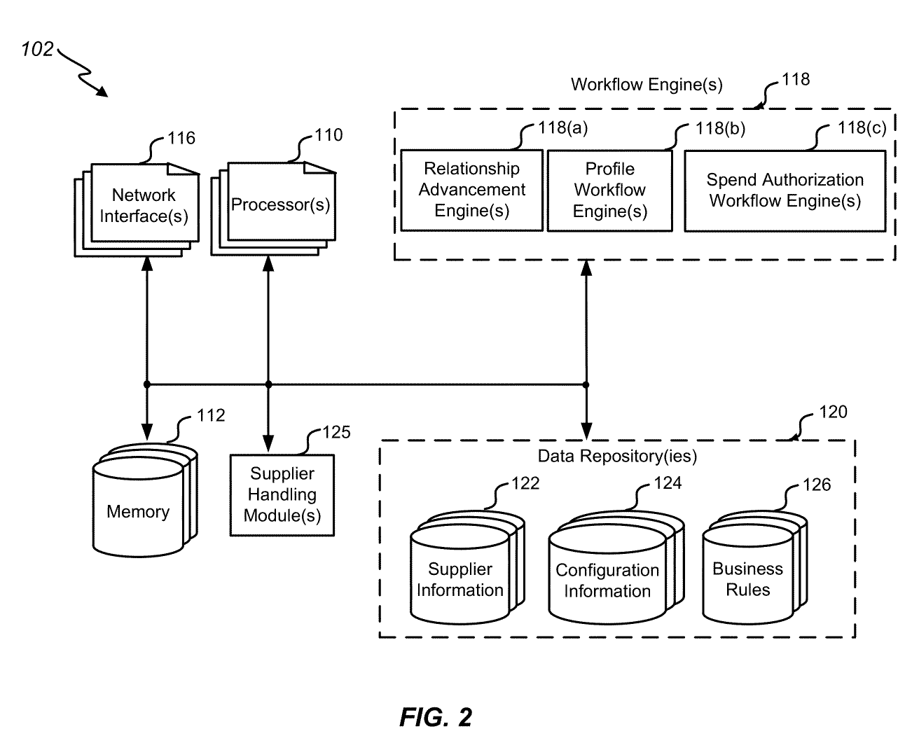

FIG. 2 shows a high-level block diagram of one example of the supplier information handling system 102, in accordance with certain embodiments of the present disclosure. While engines, modules, repositories, and other components are described separately herein, it should be appreciated that the components may be combined and/or implemented differently in any combination to provide certain features in various embodiments. In various embodiments, different processes running on one or more shared computers may implement some of the components.

As depicted, the supplier information handling system 102 may include one or more processors 110 communicatively coupled to one or more memories 112. In certain embodiments, one or more processors 110 may correspond to one or more servers, which may include communication servers, web servers, gateways, application servers, database servers, and/or one or more other types of servers. In certain embodiments, the supplier information handling system 102 may be implemented in or with a distributed computing and/or cloud computing environment with a plurality of servers and cloud-implemented processing, memory, and data resources. Thus, with accretion of supplier information, the system may allow for scaling out with additional processing resources, server resources, data storage resources, data management resources, and the like. Some embodiments may use different types of servers to service different types of computing devices.

The supplier information handling system 102 may include one or more network interfaces 116 communicatively coupled to processors 110. The network interface(s) 116 may include any suitable input/output module or other system/device operable to serve as an interface between one or more components of the supplier information handling system 102 and the network 104. The supplier information handling system 102 may use the network interfaces 116 to communicate over the network 104 using any suitable transmission protocol and/or standard.

In some embodiments, one or more servers may communicate via one or more types of communication protocols, such as HyperText Transfer Protocol (HTTP), File Transfer Protocol (FTP), Wireless Application Protocol (WAP), etc. A server may provide static web pages, dynamic web pages, web services, web applications to a computing device of a supplier 106 for execution in a web browser running on the computing device, scripts for execution within an isolated environment in a browser, and/or rich-client applications to the computing device that may have access to functions of the operating system running on the computing device.

The supplier information handling system 102 may include one or more data repositories 120. The supplier information repositories 120 may include database(s), database management system(s), server(s) to facilitate management/provision/transfer of supplier information, and the like. One or more supplier information repositories 120 may retain any supplier information suitable for embodiments of this disclosure.

The one or more data repositories 120 may include one or more supplier information repositories 122. The one or more supplier information repositories 122 may retain supplier information of particular suppliers. For example, one or more supplier information repositories 122 may retain any information related to supplier profiles, supplier authentication information, supplier change requests, supplier statuses, supplier relationships, and/or the like.

The one or more data repositories 120 may include one or more configuration information repositories 124. The one or more configuration information repositories 124 may retain information related to any configuration parameter of the system. For example, one or more configuration information repositories 124 may retain any information related to buyer customization of a supplier portal, buyer specification of profile elements, buyer notification customizations, and/or the like.

The one or more data repositories 120 may include one or more business rules repositories 126. The one or more business rules repositories 126 may retain information related to a buyer's internal controls on executing business with the supplier. For example, one or more business rules repositories 126 may retain any information related registrations, relationship advancements, routing of action items, reviews, approvals, security, and/or the like.

The supplier information handling system 102 may include one or more supplier handling modules 125. The supplier handling module(s) 125 may be stored in one or more memories 112. The supplier handling module(s) 125 may provide functionality when executed by one or more processors 110 to provide enhanced supplier handling features described herein. For example, the supplier handling module(s) 125 may provide overall handling of supplier interactions.

Various embodiments of the supplier information handling system 102 may also include one or more workflow engines 118 and/or modules to implement any combination of features of embodiments described in the present disclosure. In various embodiments, the engines 118 may include one or more of relationship advancements engine(s) 118(a), supplier profile workflow engine(s) 118(b), and/or spend authorization workflow engine(s) 118(c). While the engines 118(a)-(c) are shown separately, it should be appreciated that in various embodiments the one or more engines 118 may be implemented collectively and/or integrally. The engines 118 may be stored in memory 112 and may include one or more software applications, or components thereof, executable with the one or more processors 110, provide enhanced supplier handling features described herein. The engines 118 may be configured to perform any of the steps of methods described in the present disclosure.

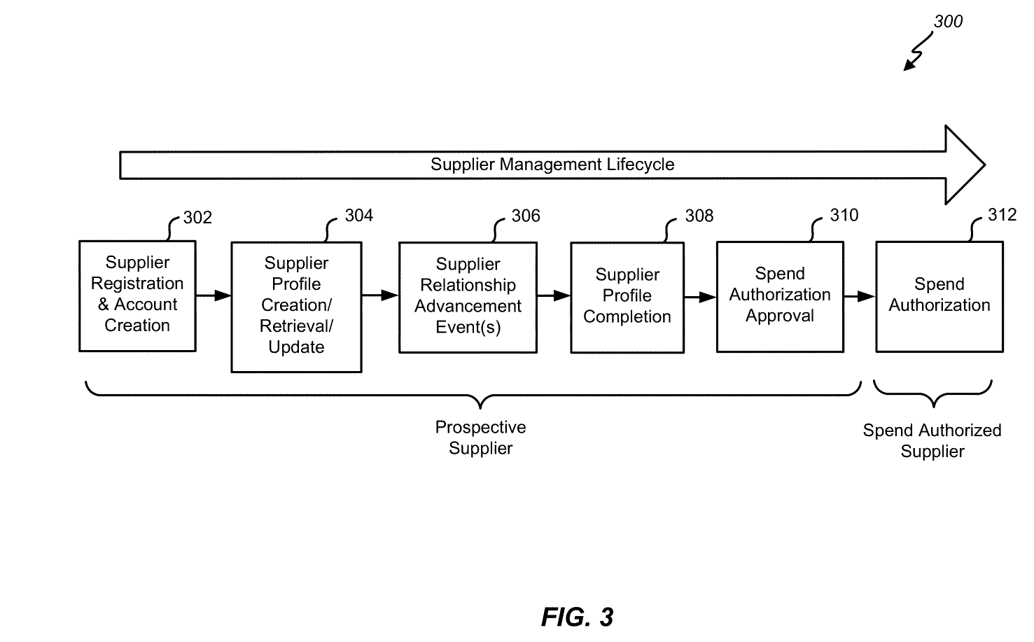

FIG. 3 is a block diagram 300 that illustrates certain aspects of a supplier management lifecycle, in accordance with certain embodiments of the present disclosure. Diagram 300 may represent an overview of certain aspects of such a lifecycle, including overall flow(s) involved.

One phase of the life cycle may correspond to a set of interactions with a prospective supplier. A prospective supplier may include a supplier entity that has not yet been approved for actual contracting, ordering and/or spending. A prospective supplier may include a supplier entity that has been approved for limited interaction with a buying organization, such as responding to sourcing negotiations and providing supplier qualification information. A prospective supplier may be identified in the supplier information handling system 102 by a business relationship attribute. For example, a business relationship attribute may indicate that a supplier is prospective.

The prospective supplier phase of the life cycle may include a supplier registration and account creation stage, as indicated by block 302. In some embodiments, one or more automated process flows may facilitate the provisioning of suppliers with accounts, the right roles, and security access. Supplier accounts may be created in various ways in various embodiments. For example, account creation may be initiated by a buyer. A buying organization may initiate an agreement with a supplier by sending the supplier a notification with a link, inviting the supplier to register. In certain cases, an existing supplier with whom business has already been transacted may already be in the system, and either the supplier or the buying organization may request access to the supplier portal, which may require registering a user account. The registration flow may include an onboarding process. Along with the registration, a supplier account may be created so that the supplier can get access to the supplier portal application, once approved.

The prospective supplier phase of the life cycle may include a supplier profile stage, as indicated by block 304. Once a supplier has an account, there are certain points in the life cycle of supplier management where certain information needs to be collected from the supplier before doing further business, such as ordering from and paying the supplier. There may be a number of suppliers in the system from whom a buyer has received quotes or bids, but with whom the buyer has never actually executed business. In various embodiments, a supplier profile may be created, retrieved, and/or updated. For example, a supplier profile could be created along with the registration of supplier. As another example, an existing supplier with whom business has already been transacted may already be in the system, and may already have a profile that may be retrieval and/or updated.

A supplier profile may include persistent information that is maintained about a supplier and/or supplier site. A supplier profile may include any data stored in a supplier information repository whether or not it is part of the profile as shown to a supplier via a supplier portal. A supplier profile may include extensible attributes and/or descriptive flex fields. It may be important for suppliers to maintain supplier profile information on a regular basis in order to conduct business. Supplier profile information may include, without limitation, one or more of address information, contact information, certification information, tax information, information on locations, diversity classifications information, billing information, preferred payment methods, bank account information, tax identifications, and/or the like.

The prospective supplier phase of the life cycle may include a stage directed to supplier relationship advancement event(s), as indicated by block 306. The buying organization may indicate that a supplier is ready for promotion of their relationship. This may be indicated by an internal supplier management attribute. The supplier relationship advancement event(s) may correspond to a number of trigger points. A trigger point could include self-service registration. A trigger point could correspond to a promotion of a supplier based on a sourcing event, which may include an automatic trigger to launch from a sourcing award action in a sourcing module. A trigger could include an action option to launch manually on the prospective supplier record in supplier management. The buyer could manually trigger the flow advancement.

The prospective supplier phase of the life cycle may include a stage directed to supplier profile completion, as indicated by block 308. A supplier profile update task may be launched when the supplier profile completion stage is initiated. In various embodiments, supplier profile review may be automatically initiated following one or more of: approval of a supplier registration request with intent to establish spend authorized relationship with the supplier (the supplier is created successfully); promotion of a supplier to be spend authorized (e.g., via a sourcing award or manual promotion); and/or a manual submission for a supplier for spend authorization review which was previously rejected.

Thus, after there is an initiative to start doing business, such as when a given supplier has been awarded a contract through a sourcing event or other triggers occur, the flow may transition to the supplier profile completion stage to ensure that the supplier's profile is complete. For example, the buyer may not have previously done business with a particular supplier and may need to obtain key information that constitutes a completed profile. Thus, in some embodiments, once a supplier is advanced to the supplier profile completion stage, notification(s) may be automatically sent to that supplier, prompting the supplier to complete the supplier's profile via the supplier portal if the profile is not complete.

Supplier management process automation may facilitate the collection of company profile information from a supplier into the procurement application of the buying organization. A workflow provided to a supplier user may be automatically initiated to collect all required company profile information which includes information about locations, contacts, diversity classifications, preferred payment methods, bank account information, tax identifications, etc. The profile completion flow may communicate to a supplier user what profile information is missing and required and may provide intuitive navigation for reviewing and entering required profile information. The profile completion flow may enable the user to review their requested changes and submit. An approval workflow may allow the buying organization to review all profile changes submitted by the supplier user. With an approval or a rejection, a supplier user may be notified that profile changes were approved or rejected. In the case of a rejection, the rejection reason may be communicated. Upon approval of profile changes, changes may be applied to the supplier record, and the record may be made available for transaction processing. If the profile completion request was initiated from sourcing, a sourcing module may be notified.

In some embodiments, supplier profile completion may be a sub-flow of spend authorization promotion. When buyer is ready to do business with supplier there's a trigger event to initiate spend authorization request that will result in updating business relationship to spend authorized from prospective so transactions can be created for the supplier. Profile completion sub-flow executes in front of the actual spend authorization request to get the supplier to review and complete profile. The outcome may be an approved profile change request, which then initiates the spend authorization request which is the internal review of the entire supplier record, particularly the internal business terms and controls that govern how business will be executed with the supplier (the more internal information on the supplier profile). In registration flow (supplier records created via a registration) after company registration is approved, a profile completion sub-flow may not be executed because the supplier provided all their profile information in the registration. A registration may be approved with an intended business relationship of spend authorized, then the supplier record may be created and enter into spend authorization request flow to trigger the internal review of the supplier record to ensure all the internal business terms/controls are set for the supplier before supplier is ‘transactionable.’ This is where the temporary ‘none’ state for the business relationship may be used, representing that the supplier is currently pending review/approval for spend authorization. Once the spend authorization request is approved, the relationship for the supplier record may update from none to spend authorized. For already existing prospective suppliers that go through the promotion flow triggering the spend authorization request, the none status may not be used. The none state may only be used with the registration flow—a supplier created from approved registration with intent to be spend authorized.

The prospective supplier phase of the life cycle may include a stage directed to spend authorization approval, as indicated by block 310. A spend authorization review process may involve a review of a supplier profile by a buying organization to determine if the profile is correct and complete before spend can be executed with the supplier. During the spend authorization review, internal user(s) from the buying organization may need to: review the profile for accuracy; configure the profile if needed, such as setting up site attributes like communication method and particularly a number of internal business terms and controls that govern how order, payment and receipt transactions (for example) will be processed with the supplier; and/or approve the business relationship to be spend authorized, which may update the business relationship. A spend authorization review process may be enhanced by facilitating collection of any missing required information from a supplier prior to review by a buying organization. With all required profile details having been obtained from the supplier, the information may be validated against business rules to ensure all internal controls on executing business with the supplier are satisfied so that the supplier may be spend authorized. A spend authorized supplier may include a supplier with whom there is intent to procure goods and services (i.e., a supplier that can be used on purchase orders, contracts, purchase agreements, invoices, etc.). The spend authorization review may be completed once the approval decision is made, the business relationship of the supplier is updated if applicable, and the users are notified.

As indicated by block 312, upon final approval, the supplier may be spend authorized and available to transact business and execute orders and agreements. A spend authorized supplier may be identified in the system by a business relationship attribute. For example, a business relationship attribute may indicate that a supplier is spend authorized.

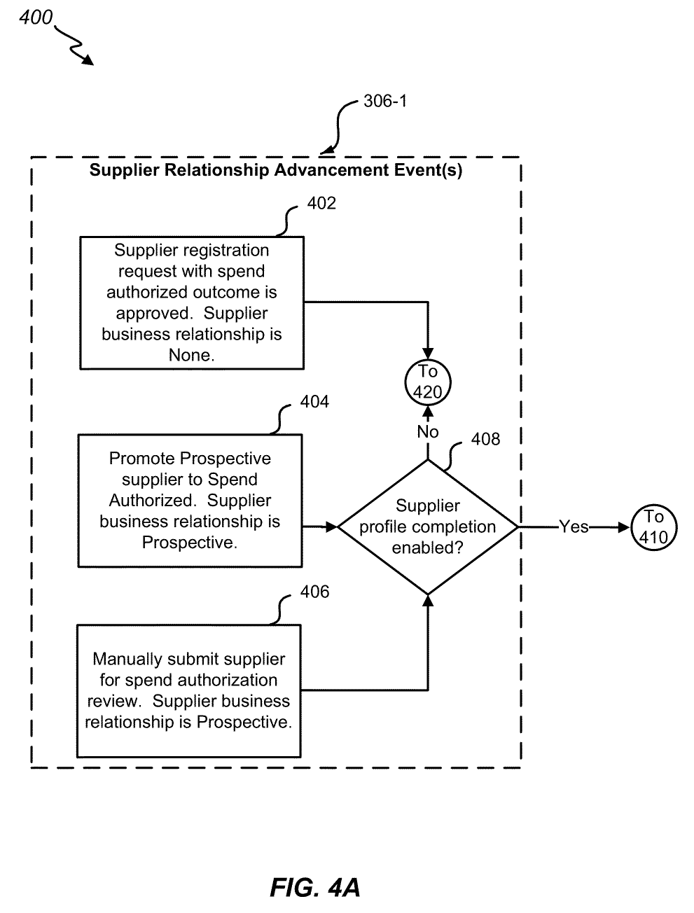

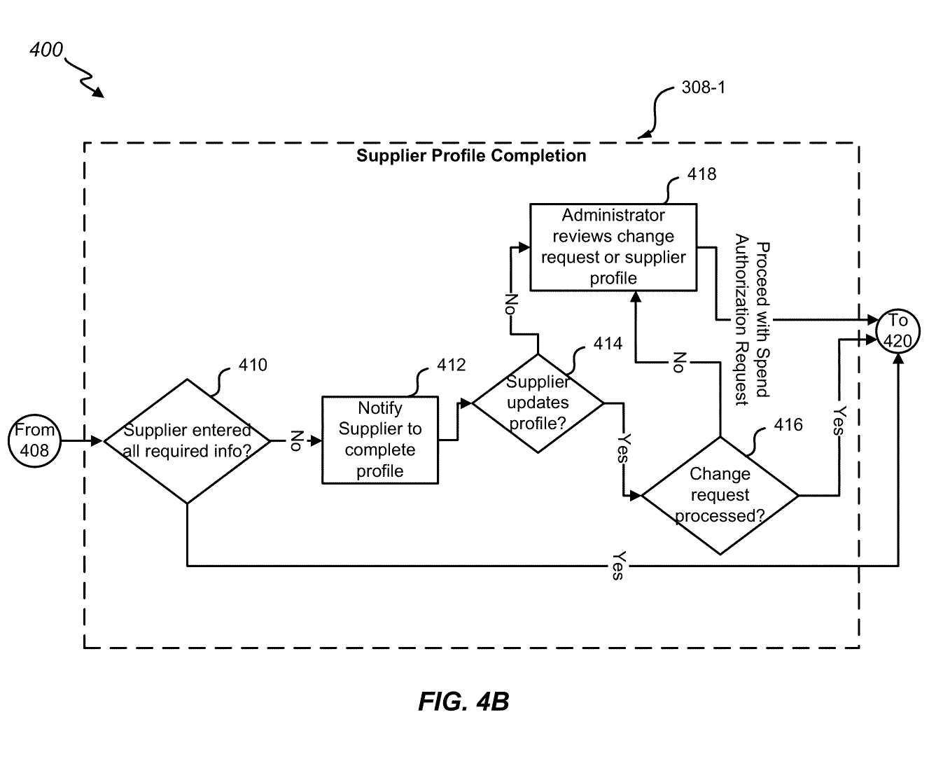

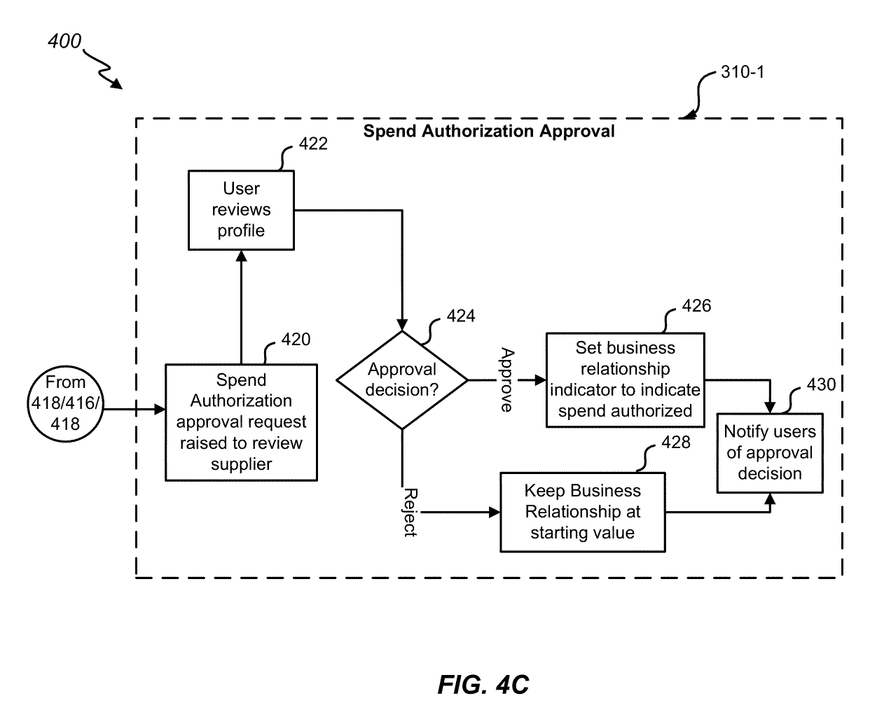

FIGS. 4A, 4B, and 4C illustrate an example flow diagram for a process 400 corresponding to certain aspects of a supplier management lifecycle, in accordance with certain embodiments of the present disclosure. Teachings of the present disclosure may be implemented in a variety of configurations that may correspond to the systems disclosed herein. As such, certain steps of the process 400, and the other methods disclosed herein, may be omitted, and the order of the steps may be shuffled in any suitable manner and may depend on the implementation chosen. Moreover, while the following steps of the process 400, and those of the other methods disclosed herein, may be separated for the sake of description, it should be understood that certain steps may be performed simultaneously or substantially simultaneously.

The process 400 may include a supplier relationship advancement event flow 306-1, a supplier profile completion flow 308-1, and a spend authorization approval flow 310-1. The supplier relationship advancement event flow 306-1, supplier profile completion flow 308-1, and spend authorization approval flow 310-1 may correspond respectively to stages 306, 308, and 310 of diagram 300. According to certain embodiments, the process 400 may begin with the supplier relationship advancement event flow 306-1.

The supplier relationship advancement event flow 306-1 may include one or more event points, for example, as indicated by blocks 402, 404, 406. The event points may correspond to various triggers which can advance a prospective supplier relationship. Any one or combination of the triggers may be ways to effect transition to the supplier profile completion flow, according to various embodiments.

In some embodiments, as indicated by block 402, a way in which a supplier relationship can advance may include a supplier registration request with a spend authorized outcome that may be approved. In some embodiments, an attribute for the supplier business relationship may be identified as “none” to indicate that a previous business relationship did not exist. In some embodiments, a supplier may be automatically identified as a spend-authorized supplier. This event may correspond to a supplier being pre-identified as a supplier of interest. For example, a company may be pre-approved before the registration process. A buyer could identify a supplier as pre-approved in any number of situations based on prior knowledge and/or relationships. As another example, a buyer may set an intended relationship for a particular supplier to spend authorized on the registration, knowing they intend to do business with the supplier immediately. The supplier could be in the supplier registration flow, and, during the approval of that flow, the buyer might review the registration and approve the supplier. For instance, the buyer could have been expecting that particular registration. The buyer may intend to immediately start doing business with the supplier.

In some embodiments, as indicated by block 404, a way in which a prospective supplier relationship can advance may include a business relationship promotion being triggered automatically from a sourcing award, which may include a prospective supplier being promoted to spend authorized. In some embodiments, an attribute for the supplier business relationship may be identified as “prospective” to indicate a previous business relationship corresponding prospective. For example, the supplier may have been selected for or awarded the promotion after going through a competitive bid situation. Thus, the supplier's relationship as a prospective supplier may advance toward requesting spend authorization.

In some embodiments, as indicated by block 406, a way in which a prospective supplier relationship can advance may include a supplier being manually submitted for spend authorization review in some embodiments. In some embodiments, an attribute for the supplier business relationship may be identified as “prospective.” The buyer, or one acting on behalf of the buyer, may intend to create an agreement with a particular supplier, may pull up the record, and may manually request promotion of the supplier. In some embodiments, the promotion may be directly to spend-authorized. Accordingly, in promoting a prospective supplier to spend authorized or manually submitting a supplier for spend authorization review, buyers may have the ability to enable a supplier completion feature to have the supplier provide all the required information before initiating spend authorization approval request.

As indicated by block 408, it may be determined whether the supplier profile completion flow 308-1 is enabled. A buyer may have the ability to enable the supplier completion feature to have supplier provide all the required information before initiating spend authorization approval request. Thus, the application may first check whether profile completion is enabled. In the case of a determination that the supplier profile completion flow 308-1 is enabled, the flow may transition to the supplier profile completion flow 308-1. However, in the case of a determination that the supplier profile completion flow 308-1 is not enabled, the flow may transition to block 420. As indicated by block 420, a user of the buyer system may be notified so that the supplier profile may be reviewed. When profile completion not enabled, the system may directly initiate the spend authorization request facilitating the internal review of the supplier profile.

When the profile completion is enabled, it may be determined whether the supplier has entered all required information, as indicated by block 410. The system may check the supplier's profile details and compare those details to requirements for a spend authorized supplier. In some embodiments, the profile may be deemed complete if there is at least one active record existing for each of the profile items marked as required for spend authorization.

In the case of a determination that the supplier profile does meet all of the requirements, the flow may transition to block 420, and a buyer side user of the system may be notified with a spend authorization request so that the supplier record can be reviewed to determine if it is ready to transact. In the case of a determination that the supplier profile fails to meet all of the requirements, the flow may transition to block 412. As indicated by block 412, a notification may be triggered and routed to the supplier. For example, if the supplier profile is deemed incomplete, the application may send a notification to supplier users who have the function security to edit profile from the supplier portal. The notification may communicate to the recipient that the buying organization is considering doing business with the supplier and thus would need the users to provide more information. The notification may invite the supplier to complete the supplier's profile via the portal.

Any suitable means of notification may be employed. For example, text, voice, email, alerts with the application, and/or the like could be sent. The notification could include a link or other communication reference referring back to the portal provided by the supplier information handling system 102, prompting the supplier to provide the required information. For example, the notification may provide a link for users to log into the supplier portal to complete the profile. The supplier also could be sent reminders. The reminders could be periodically sent according to a default frequency or according to the buyer's and/or supplier preferences stored in the supplier information handling system 102.

Accordingly, embodiments may provide for the ability for suppliers to complete supplier profiles from the supplier portal. The supplier user may be allowed to provide important information via supplier portal so that the buying organization can collect the information in time to review and establish a spend authorized relationship with the supplier. Via the supplier portal, there may be a user interface region that highlights the completion status of the profile. A supplier user could navigate into the incomplete profile area(s) to update. The supplier user could save the changes, which may consolidate all updates into a single change request to submit.

As indicated by block 414, consequent to the notification, it may be determined whether the supplier updates the supplier's profile. In the case of a determination that the supplier has not updated the supplier's profile, the flow may transition to block 418. In the case of a determination that the supplier updates the supplier's profile, the flow may transition to block 416. A profile change request may be generated and submitted to the buyer so that provided information can be reviewed to ensure that validity and sufficiency, meeting the buyer's requirements before executing spend and engaging in a contractual procurement obligation. A supplier profile change request may be a logical business entity that contains a change proposed on a given supplier profile. A supplier profile change request can be created by a supplier as a result of reviewing and completing their profile.

As indicated by block 416, it may be determined whether an approved supplier profile change request has been processed and applied to supplier profile record. In the case of a determination that a supplier profile change request has been processed, the flow may transition to block 420 of the spend authorization approval flow 310-1. However, in the case of a determination that a supplier profile change request has not been processed, the flow may transition to block 418.

As indicated by block 418, a user, such as an administrator, may review the change request or the supplier profile, as the case may be. For example, the change request may be routed for approval by a supplier profile change request approval human task. Approved changes may be applied to the supplier profile, and supplier users may be notified of an approval outcome for the change request. A buyer side administrator can monitor suppliers having pending profile completion cases from a supplier side work area from a supplier management work area. The administrator user may be able to decide whether to manually proceed with a spend authorization request for a supplier. Such a decision could launch a spend authorization approval task flow. In some embodiments, administrator review may handle one or more exception cases: 1) review approved profile change requests that errored out when system attempted to apply to supplier record; and/or 2) review suppliers that did not take action from profile completion request—an administrator can make profile updates if the supplier is unable to do it for some reason to ensure that the supplier record can move into the spend authorization request flow.

If the administrator indicates that the spend authorization request may proceed, the flow may transition to block 420 of the spend authorization approval flow 310-1. The supplier profile completion phase 308-1 may be finished when the profile change request is approved and processed successfully. The flow may move onto spend authorization review, and a spend authorization approval task may be launched. However, if a supplier user did not complete profile, the spend authorization approval task may not be launched, or a buyer-side administrator could complete the profile on their behalf in order to proceed with spend authorization approval.

As indicated by block 420, a user may be notified so that the profile may be reviewed. A spend authorization approval request may be raised to review the supplier. As indicated by block 422, a user may review the profile. More specifically, a user may receive spend authorization approval request for the supplier. As indicated by block 424, it may be determined whether an approval decision has been made. In the case of a determination that an approval decision has been made and the spend authorization request is approved, the flow may transition to block 426. However, in the case of a determination that an approval decision has not been made, the flow may transition to block 428. In the event that the spend authorization request raised from supplier profile completion is rejected by the buying organization, the flow may stop. A spend authorization review status field associated with the supplier profile could indicate a rejected status.

As indicated by block 428, with a rejection, the business relationship may be maintained. In the promotion case, the business relationship of the supplier may remain indicated as prospective. In the registration approval case, the business relationship may remain indicated as none. The spend authorization approval task will not be initiated. The buyer side user who requested the promotion or the spend authorization review may also be notified.

As indicated by block 426, with an approval, the business relationship may be set to spend authorized. In some embodiments, when business is awarded and financial spend is committed, the spend authorization request is raised and upon approval the business relationship attribute may be converted from indicating prospective to indicating that a supplier is spend authorized.

As indicated by block 430, one or more users may be notified of the approval decision. For example, one or more users internal to the buyer organization may be notified. Consequently, business may be transacted between the buyer and the supplier.

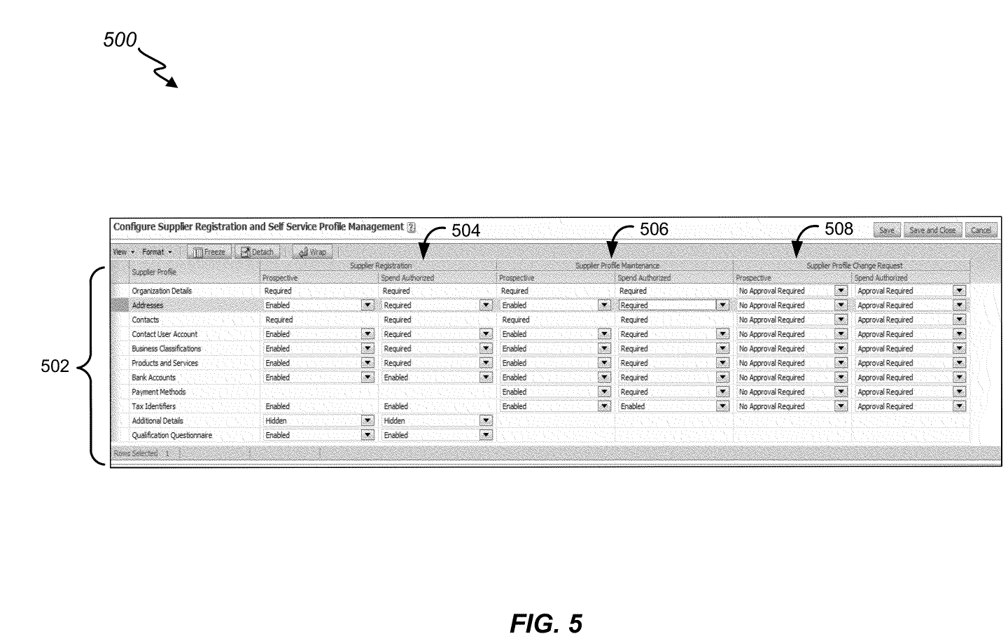

FIG. 5 is a screenshot illustrating an example user interface 500 for configuring supplier registration and self-service profile management, in accordance with certain embodiments of the present disclosure. While the exemplary display screens described herein employ specific user interface elements appropriate for the type of information to be conveyed/received by computer system in accordance with the described embodiments, it should be appreciated that the choice of user interface element for a particular purpose is typically implementation-dependent and/or discretionary. Hence, the illustrated user interface elements employed by the display screens described herein should be considered exemplary in nature, and the reader should appreciate that other user interface elements could be substituted within the scope of various embodiments.

With the user interface 500, a supplier can manage profile data. The user interface 500 may allow a user, such as an internal administrator, to specify what profile elements are required to constitute a complete profile for a spend-authorized supplier. Thus, with respect to certain profile areas, a buyer can specify fields that are required when shown at the supplier portal. A setup page may contain a choice list to globally switch on or off a supplier profile completion feature. If the feature is turned off, when prospective supplier is requested to become spend authorized, the profile completion may be skipped and spend authorization approval request may be generated right away. The setup page may also contain a text input field to set the days when the supplier profile completion may become due. For example, it can be in 7, 15 or 30 days from the date when the completion notification is sent. Additionally, a user could be able to configure when the profile completion reminder notification may be sent out.

This may allow buying organizations to capture key profile information from supplier in order to make it spend authorized and transaction ready or to maintain the supplier as an eligible spend authorized supplier. This may reduce work for supplier administrators. Thus, the user may specify the list of profile information items 502 that are required based on supplier's business relationship when a supplier updates a profile from the supplier portal. By way of example without limitation, a list of profile information items 502 that can be set as required for spend authorization may include any one or combination of:
Organization Details
Business Classifications
Products and Services
Payment Methods (controls supplier level payment methods and address level payment methods)
Bank Accounts (controls supplier level bank accounts and address level bank accounts)
Addresses (controls Address Contacts)
Contacts
Contact User Account
Tax Identifiers (controls transaction tax attributes for both supplier level and address level and income tax attributes)
Additional Details
Qualification Questionnaire

When an information item 502 is marked as required, it may mean that the supplier must provide at least one active record for that item. For example, if an item corresponding to bank accounts is set as required, the supplier may be required to provide information for at least one active bank account. In some embodiments, the required configuration may be applicable or enforced only to supplier profile updates initiated from the supplier portal or to suppliers that are requested to complete their profile because they are being promoted to a spend authorized supplier. In various embodiments, supplier profile information items 502 may be selectively specified for various stages. For example, the user interface 500 may include any one or combination of supplier registration options 504, supplier profile maintenance options 506, and/or supplier profile change requests options 508. In some embodiments, supplier maintenance may refer to when a supplier in the portal is updating their profile, which raises profile change requests; thus, supplier maintenance and supplier profile change requests could be overlapping and integrated options in some embodiments. Each of the options may allow for distinguishing requirements as between prospective suppliers and spend authorized suppliers. Thus, requirements can depend on the business relationship. For example, a supplier can only have participated in a sourcing event, or a supplier could have already transacted with the buyer, and the buyer may specify different requirements for the different cases.

Further, options may allow for profile change requests submitted by suppliers as requiring or not requiring approval, as well as being hidden from the supplier's portal view or not being hidden. The supplier registration options 504 may correspond to what information items are required at the registration stage. The supplier profile maintenance options 506 may correspond to what information items are required at the profile completion stage, and may be used to determine if a supplier profile is complete for spend authorization approval. The supplier profile change requests options 508 may correspond to what information items require approval at the profile change request stage.

In some embodiments, the user interface 500 may provide a user with the ability to define supplier profile elements that are change controlled, e.g., that any change made to a profile entity, including its attributes, by the supplier will require approval. A page of the user interface 500 could list all the supplier profile entities that can be put under change control. Some embodiments could include listing extensible attributes/UI elements added to the supplier profile through an extensibility framework for the supplier profile. Some embodiments could, by default, have nothing on the profile that is marked for control. Accordingly, a user, such as a procurement application administrator, may have the function security to setup or update the supplier profile change configuration. This may allow a buying organization to have a better control of supplier profile data quality and improve accountability. And it may make it possible for system to enforce control and track change history on supplier profile data.

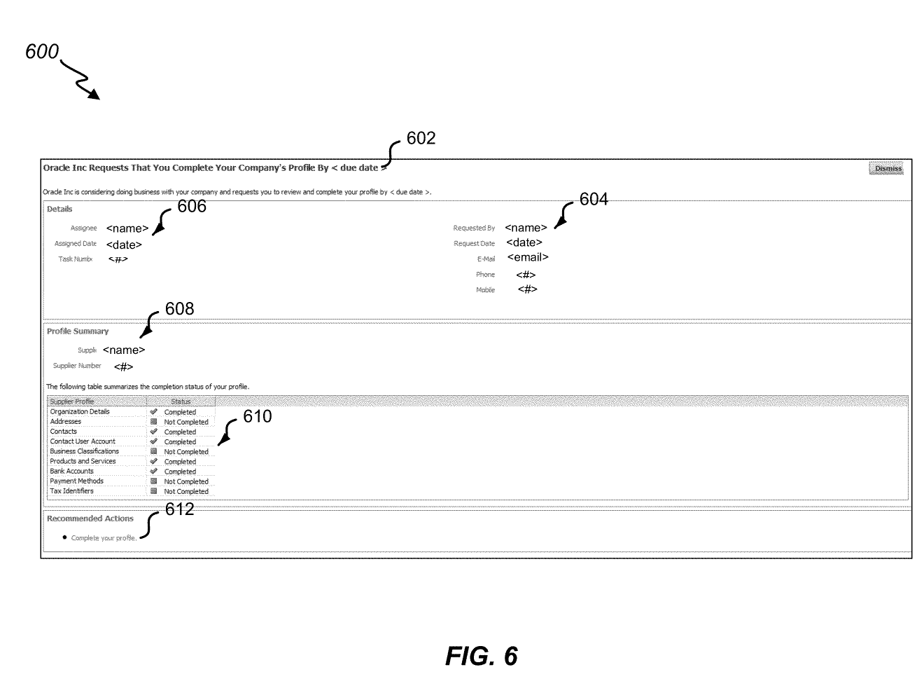

FIG. 6 is a screenshot illustrating an example supplier side user notification 600 for notifying a supplier side user regarding a request for supplier to complete a supplier profile, in accordance with certain embodiments of the present disclosure. As illustrated in the example user notification 600, some embodiments may allow for a buyer side user to set a due date 602 for supplier profile completion. The notification 600 may communicate to the recipient that the buying organization is considering doing business with the supplier and thus would need the users to provide more information. The notification 600 could indicate any one or combination of buyer side contact information 604, task details 606, supplier details 608, profile item status information 610, a link or other communication reference 612 referring back to the supplier portal, and/or the like.

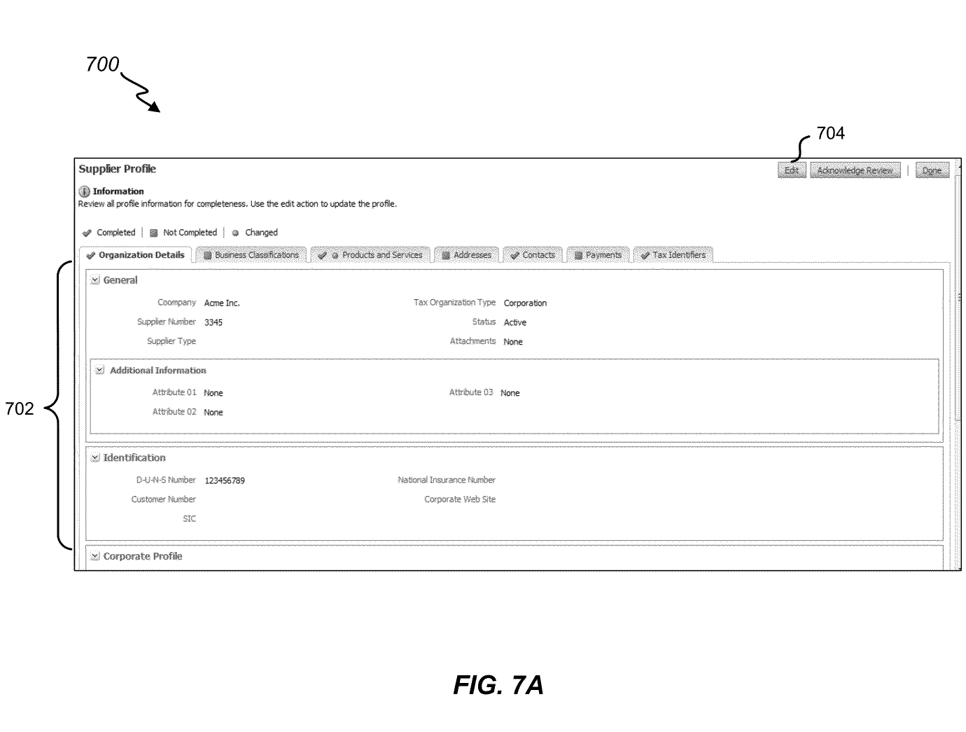

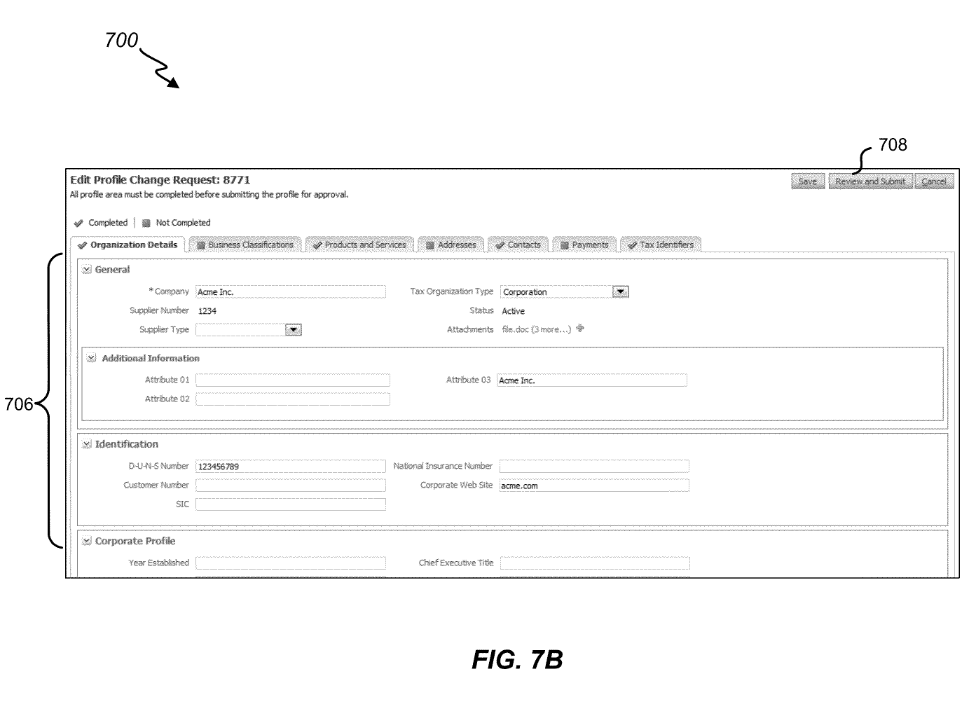

FIGS. 7A and 7B are screenshots illustrating an example user interface 700 for a supplier side user to view and update a supplier profile, in accordance with certain embodiments of the present disclosure. The example user interface 700 may allow a supplier user to navigate to view a supplier profile, like that which is depicted in FIG. 7A. The example user interface 700 may provide for access to profile information items 702. The example user interface 700 may indicate status information for one or more of the profile information items 702. While one example is depicted, status information for one or more of the profile information items 702 may be graphically indicated and distinguished in any suitable way, including with varieties of colors, icons, and the like. Various views, such as detailed views of the profile information items 702, may be provided. Detailed views could be user-selectable options with tabs, like that which is depicted.

If there is a need to update the profile, a flow can walk the user through all of the missing elements need to be provided. The flow could be a page flow. A user can select an edit option 704. Selection of the edit option 704 may allow for presentation of editable information fields 706 for profile information items 702, like that which is depicted in FIG. 7B. Incomplete fields could be highlighted, simultaneously or in succession as the user completes the fields. When a prospective supplier makes changes on the profile from supplier portal, the application may prompt the user to provide all the required profile information.

And selection of the edit option 704 could create a draft profile change request in the system. The user can update one or more profile information items throughout the profile, and the changes may be included in a profile change request for the user to submit with selection of an option 708 to submit. Supplier users could save a draft of the changes they are requesting for future editing. Once saved, the draft request can be edited by the original change initiator or any other supplier users in the same company that have proper function security to edit draft profile change request. This may allow supplier profile change initiators to facilitate team collaboration and to consolidate changes for approval. These features may also allow buying organizations to engage suppliers to update their profile so as to keep supplier data more accurate. This may also help reduce the cost of maintaining supplier profiles and streamline the supplier profile management process.

In some embodiments, at one time, only one pending change request may be allowed. If there is a profile change request generated from negotiation and qualification flows that are pending approval, the supplier users may be presented with message when trying to take edit actions. Additional changes to the profile from supplier portal may be prevented until that pending approval request is resolved (rejected, cancelled, or approved).

Supplier users with proper function security may be able to edit a supplier profile from the supplier portal. Certain roles may be set by default to have the ability to edit a supplier profile. For example, the roles of Supplier Accounts Receivable Specialist (A/R Specialist), Supplier Self Service Clerk (SSC) and Supplier Self Service Administrator (SSA) may be able to edit supplier profile by default. Supplier users such roles may be the targeted recipients of profile completion request notification, since they have access to review and update profiles. Function security may be differentiated depending on particular profile information items. For example, an A/R Specialist could be the only user that has the function security, by default, to edit profile information related to payment processing (such as payment methods and bank accounts). But this user may have view-only access to the rest of the profile. Any of the function security aspects may be customizable by the buyer in some embodiments.

Upon submission, in some embodiments, the application may look at the change control definitions to determine if the request will be routed for approval first or if the changes are to be applied to the profile directly. If the request contains any change to profile elements that are change controlled, the entire profile change request may be sent for approval. Otherwise, the changes may be processed and applied to the supplier profile by the application. For spend authorized suppliers or suppliers requested to complete profile, the submission check may also verify that all the required profile information have been entered.

In some embodiments, when a supplier profile is under spend authorization review, a new field called spend authorization review status may appear on the supplier profile, indicating the value of pending approval. At this point, the supplier profile may not updatable from supplier portal. The spend authorization review status field may not appear if it does not have value.

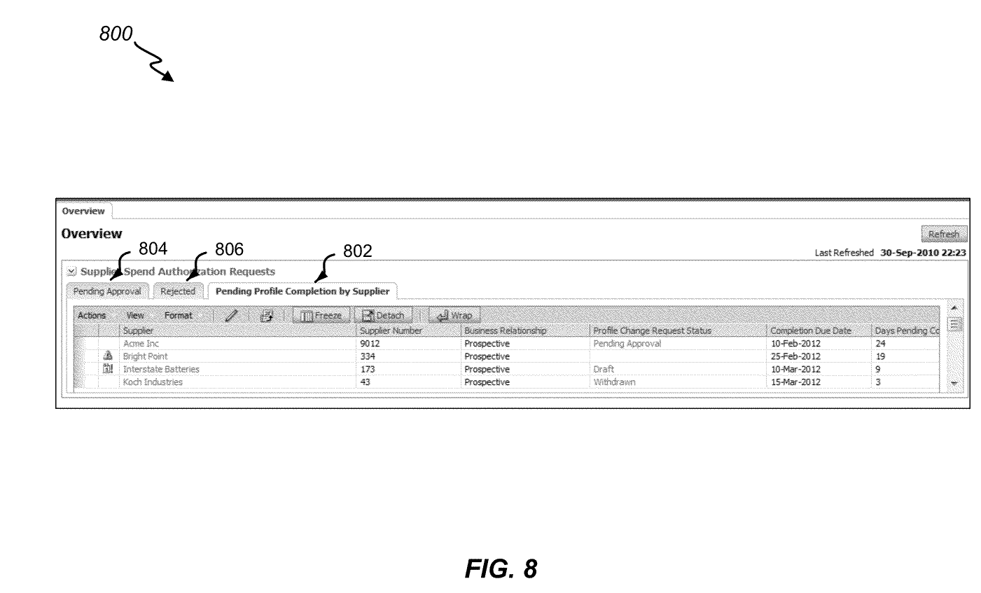

FIG. 8 is a screenshot illustrating an example user interface 800 to facilitate management of suppliers, in accordance with certain embodiments of the present disclosure. The example user interface 800 may allow internal user to access a supplier profile management application to monitor information such as pending profile completion requests information 802 sent to the supplier, pending spend authorization requests 804, rejected spend authorization requests 806, and/or the like. Various views, such as detailed views of the information 802, 804, 806, may be provided. Detailed views could be user-selectable options with tabs, like that which is depicted. This may allow a buying organization to monitor suppliers that are undergoing reviews for spend authorization so as to expedite approval process. With the example user interface 800, the administrator user may be able to decide whether to manually proceed with a spend authorization request for a supplier. Such a decision could launch a spend authorization approval task flow.

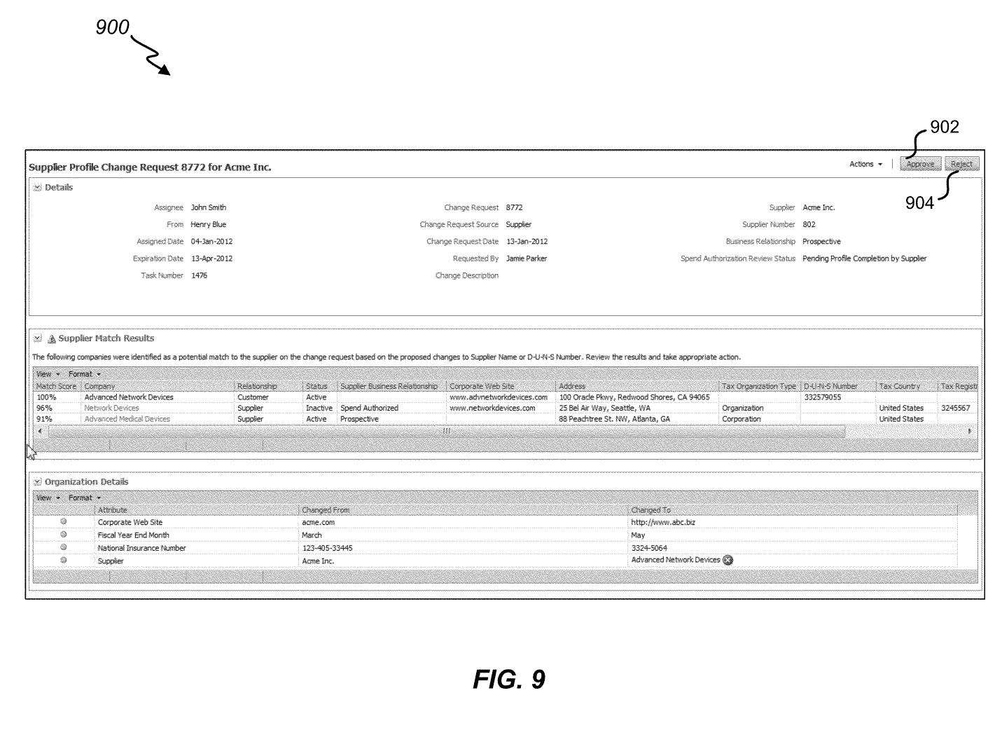

FIG. 9 is a screenshot illustrating an example user interface 900 to facilitate supplier profile change request approval, in accordance with certain embodiments of the present disclosure. The example user interface 900 may allow a buying organization to review change controlled profile changes before such are applied to supplier profile. This may help to ensure the quality and accuracy of supplier profile data.

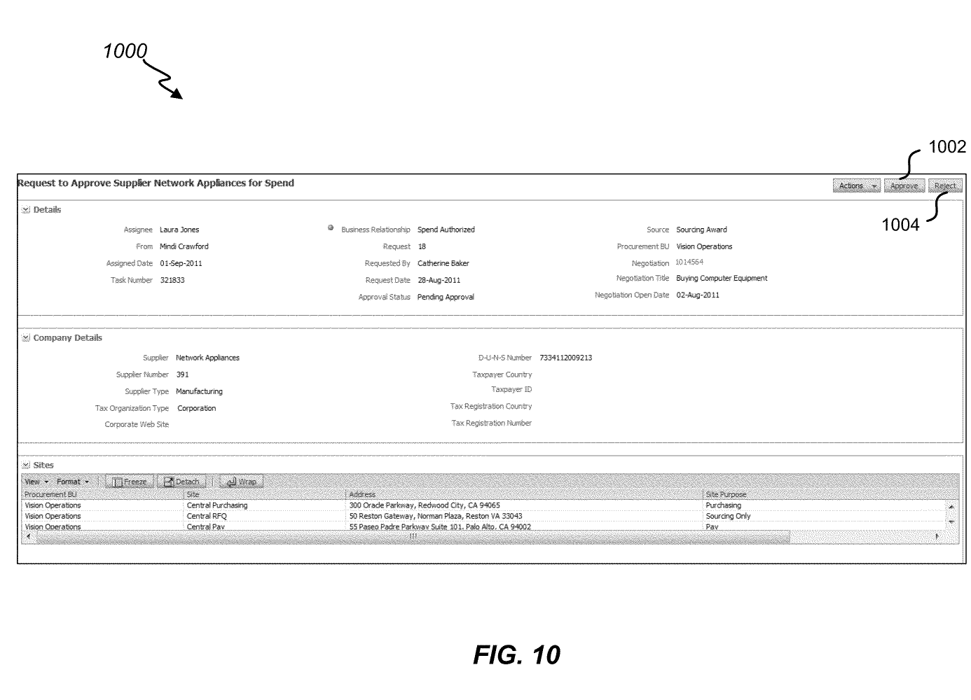

FIG. 10 is a screenshot illustrating an example user interface 1000 to facilitate approval of a supplier for spend, in accordance with certain embodiments of the present disclosure. The example user interface 1000 may allow a buying organization to review a request to approve a supplier for spend after profile changes are approved and a supplier profile is complete.

After a profile change request is submitted, the application may first need to determine whether approval is needed for the request. To do that, it may look at the profile change control setup. If the change does not involve any change controlled profile data, it may be applied to the supplier profile directly, and the request may be marked as processed. Otherwise, the request may be routed to a human workflow for approval. The routing may be based on one or more approval rules to route the change request to one or more users havening management functions for approval. In some embodiments, a voting regime may be employed. Approvers may be provided with parallel voting opportunities, and a first responder may win, which means the first approver to take approval action approves/rejects the spend authorization review request.

An approval notification may be sent to one or more approvers. The notification may include details such as information about a supplier user who submitted the request, a supplier company name, profile change details, and/or the like. The notification could include link to the supplier profile page and indication as to whether supplier profile is complete. An approver could also go to the system to view an inbox of pending approval requests.

Disposition actions for approvers may include approving the request, for example, by selection of an approval option 902 and/or 1002. When the last approver in the chain approves, the application may start to apply changes from the approved profile request to the supplier profile. When the process is completed without error, the changes may be applied to the supplier profile, and the request may be marked as processed.

Disposition actions for approvers may include rejecting the request such that none of the changes on the change request may be processed to be applied to the supplier profile. Rejection may be made, for example, by selection of a rejection option 904 and/or 1004. In some embodiments, the application may provide an approver with the ability to make edits or corrections during approval without having to approve or reject the request first. Only the user who is the current approver on the profile change request approval task may be able to edit supplier profile change request.

When an approval decision is made on a pending approval change request, the supplier user who last submitted the request may receive a notification indicating whether the profile change request was approved or rejected. If the request was rejected, a rejection reason may be provided in the notification as well. If the supplier user who submitted the request does not have email, the administrative contact(s) of the supplier may be notified instead.

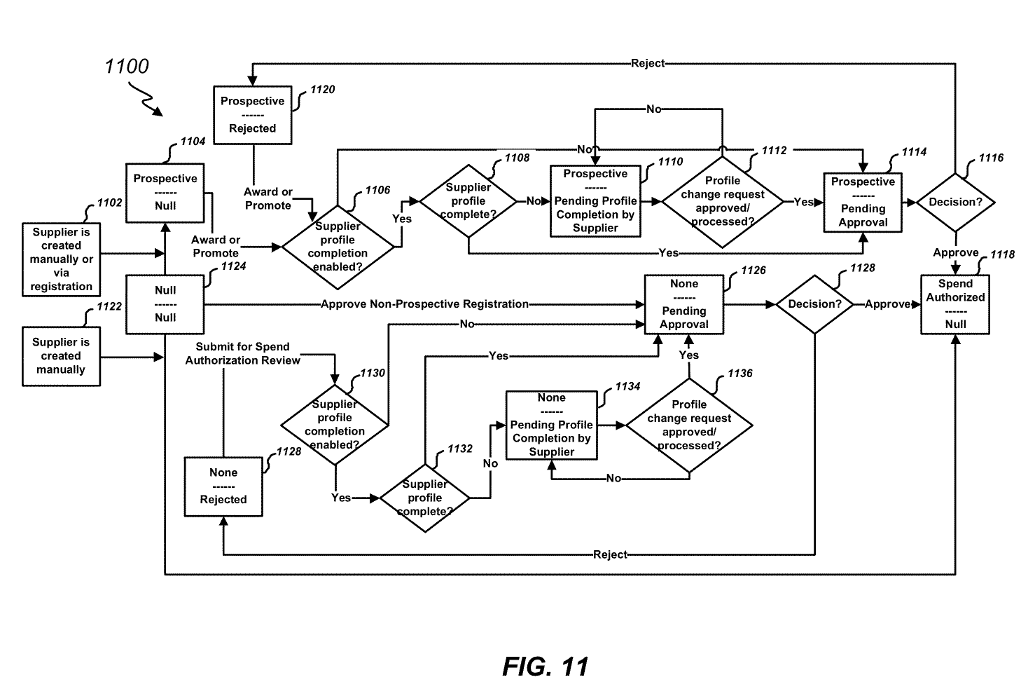

FIG. 11 is a business relationship state transition diagram 1100, in accordance with certain embodiments of the present disclosure. The business relationship state transition diagram 1100 may correspond to the supplier management process automation that facilitates the collection and review of supplier profile information from a prospective supplier into a procurement application of a buying organization so that the supplier may become spend authorized.

The business relationship state transition diagram 1100 illustrates a business relationship state and a review state. A user interface, such as one or more of the interfaces previously discussed, may include one or more fields to indicate the current business relationship state and/or review state associated with a supplier and/or supplier record. In some embodiments, the review field may be visible to the user when the value is not null. The business relationship field may be read-only. The review state field may be transient, appearing only when spend authorization requests (promotions) are in process.

As indicated by block 1102, a supplier account/record may be created manually or via registration. As indicated by block 1104, the corresponding business relationship may be indicated as prospective. The review status may be indicated as null or not shown when it is null. Following an award or promotion, for example, via an automatic trigger to launch from a sourcing award action in a sourcing module, the flow may transition to block 1106. As indicated by block 1106, it may be determined whether supplier profile completion is enabled. In the case that that supplier profile completion is not enabled, flow may transition to block 1114, which indicates that a spend authorization request is raised. However, in the case that that supplier profile completion is enabled, flow may transition to block 1108. As indicated by block 1108, it may be determined whether the supplier profile is complete. In the case that that the supplier profile is complete, flow may transition to block 1114.

However, in the case that that the supplier profile is not complete, a workflow may be automatically initiated to a prospective supplier to collect all required profile information, and flow may transition to block 1110. One or more support triggers may initiate a workflow notification which is sent to supplier contacts, which includes a link for navigating users to complete their company profile in the supplier portal application. As indicated by block 1110, the corresponding business relationship may be indicated as prospective, but the spend authorization review status may be changed to pending profile completion by the supplier. After a supplier user has submitted information by completing a profile completion page flow that communicates to the supplier user what profile information is missing and required, flow may transition to block 1112.

As indicated by block 1112, it may be determined whether a corresponding profile change request is approved and/or processed. In the case that that the corresponding profile change request is not approved and/or processed, the states indicated by block 1110 may be maintained. However, in the case that that the corresponding profile change request is approved and/or processed, flow may transition to block 1114. As indicated by block 1114, the corresponding business relationship may be indicated as prospective, but the spend authorization review status may be indicated as pending approval, indicating the profile completion sub-flow ended and the spend authorization request is initiated.

As indicated by block 1116, it may be determined whether a decision is made on the pending request. In the case that that a decision is made that the request is rejected, flow may transition to block 1120. As indicated by block 1120, the corresponding business relationship may not change to spend authorized and may remain as prospective, but the review status may be changed to rejected. From block 1120, following an award or promotion, for example, via an automatic trigger to launch from a sourcing award action in a sourcing module, the flow may transition to block 1106. However, in the case that a decision is made that the request is approved, flow may transition to block 1118. As indicated by block 1118, the corresponding business relationship may be indicated as spend authorized, and the review status may be changed to null.

As indicated by block 1122, a supplier record can be created manually with a business relationship of spend authorized, bypassing a spend authorized request/promotion process, and, hence, review status may never be used. Block 1124 indicates a starting point, before a record is created. In the case of a direct buyer intervention in favor of approval, flow may transition to block 1118, where the corresponding business relationship may be indicated as spend authorized. In the case of an approval of a non-prospective registration, flow may transition to block 1126. As indicated by block 1126, the corresponding business relationship may be indicated as none, and the review status may be indicated as pending approval.

As indicated by block 1128, it may be determined whether a decision is made on the pending request. In the case that that a decision is made that the request is approved, flow may transition to block 1118. As indicated by block 1118, the corresponding business relationship may be indicated as spend authorized, and the review status may be changed to null. However, in the case that that a decision is made that the request is rejected, flow may transition to block 1130. As indicated by block 1130, the corresponding business relationship may be maintained as none, but the review status may be changed to rejected. In the case that the request can be re-submitted for spend authorization review, flow may transition to block 1130.

As indicated by block 1130, it may be determined whether supplier profile completion is enabled. In the case that that supplier profile completion is not enabled, flow may transition back to block 1126. However, in the case that that supplier profile completion is enabled, flow may transition to block 1132. As indicated by block 1132, it may be determined whether the supplier profile is complete. In the case that that the supplier profile is complete, flow may transition back to block 1126. However, in the case that that the supplier profile is not complete, flow may transition to block 1134 and block 1136.

However, in the case that that the supplier profile is not complete, a workflow may be automatically initiated to a prospective supplier to collect all required profile information, and flow may transition to block 1134. One or more support triggers may initiate a workflow notification which is sent to supplier contacts, which includes a link for navigating users to complete their company profile in the supplier portal application. As indicated by block 1134, the corresponding business relationship may be indicated as prospective, but the review status may be changed to pending profile completion by the supplier. After a supplier user has submitted information by completing a profile completion page flow that communicates to the supplier user what profile information is missing and required, flow may transition to block 1136.

As indicated by block 1136, it may be determined whether a corresponding profile change request is approved and/or processed. In the case that that the corresponding profile change request is not approved and/or processed, the states indicated by block 1134 may be maintained. However, in the case that that the corresponding profile change request is approved and/or processed, flow may transition back to block 1126. As indicated by block 1126, the corresponding business relationship may be maintained as none, but the review status may be indicated as pending approval.

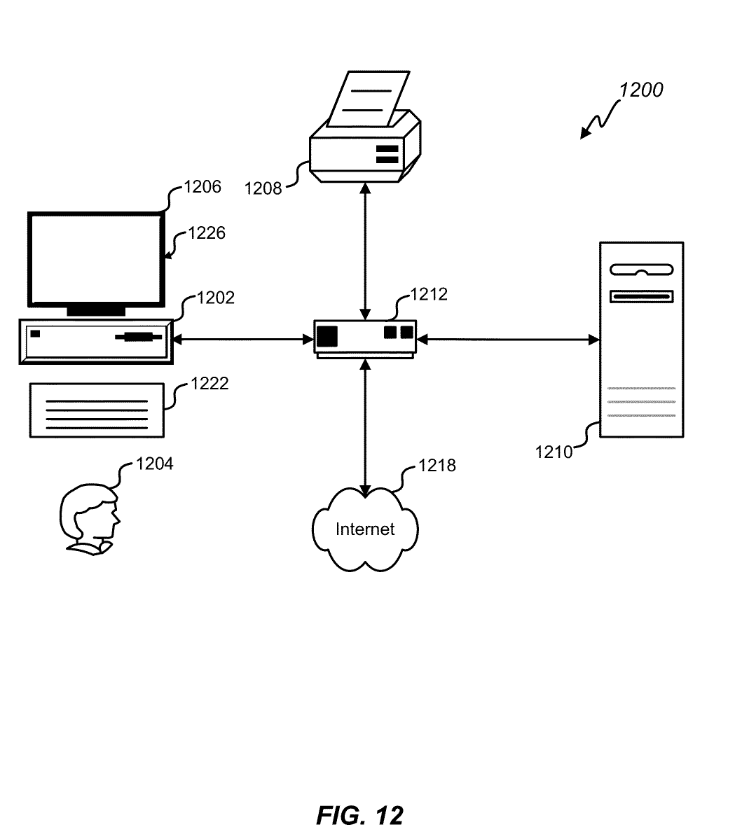

Referring next to FIG. 12, an exemplary environment with which embodiments may be implemented is shown with a computer system 1200 that can be used by a designer 1204 to design, for example, electronic designs. The computer system 1200 can include a computer 1202, keyboard 1222, a network router 1212, a printer 1208, and a monitor 1206. The monitor 1206, processor 1202 and keyboard 1222 are part of a computer system 1226, which can be a laptop computer, desktop computer, handheld computer, mainframe computer, etc. The monitor 1206 can be a CRT, flat screen, etc.

A designer 1204 can input commands into the computer 1202 using various input devices, such as a mouse, keyboard 1222, track ball, touch screen, etc. If the computer system 1200 comprises a mainframe, a designer 1204 can access the computer 1202 using, for example, a terminal or terminal interface. Additionally, the computer system 1226 may be connected to a printer 1208 and a server 1210 using a network router 1212, which may connect to the Internet 1218 or a WAN.

The server 1210 may, for example, be used to store additional software programs and data. In some embodiments, software implementing the systems and methods described herein can be stored on a storage medium in the server 1210. Thus, the software can be run from the storage medium in the server 1210. In another embodiment, software implementing the systems and methods described herein can be stored on a storage medium in the computer 1202. Thus, the software can be run from the storage medium in the computer system 1226. Therefore, in this embodiment, the software can be used whether or not computer 1202 is connected to network router 1212. Printer 1208 may be connected directly to computer 1202, in which case, the computer system 1226 can print whether or not it is connected to network router 1212.

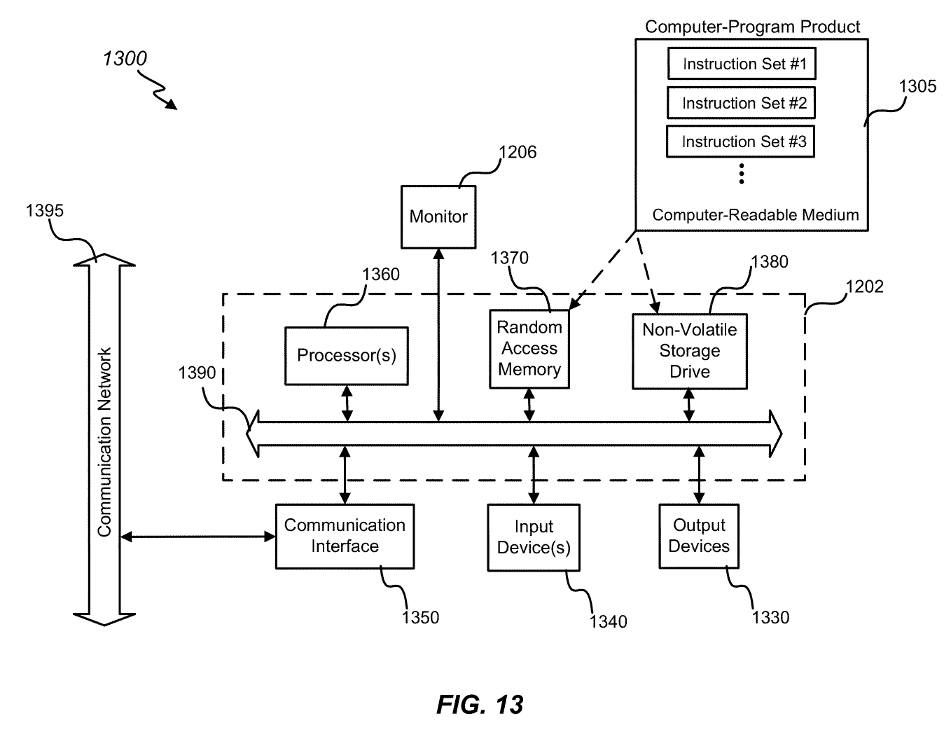

With reference to FIG. 13, an embodiment of a special-purpose computer system 1300 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 1226, it is transformed into the special-purpose computer system 1300.

Special-purpose computer system 1300 comprises a computer 1202, a monitor 1206 coupled to computer 1202, one or more additional user output devices 1330 (optional) coupled to computer 1202, one or more user input devices 1340 (e.g., keyboard, mouse, track ball, touch screen) coupled to computer 1202, an optional communications interface 1350 coupled to computer 1202, a computer-program product 1305 stored in a tangible computer-readable memory in computer 1202. Computer-program product 1305 directs system 1300 to perform the above-described methods. Computer 1202 may include one or more processors 1360 that communicate with a number of peripheral devices via a bus subsystem 1390. These peripheral devices may include user output device(s) 1330, user input device(s) 1340, communications interface 1350, and a storage subsystem, such as random access memory (RAM) 1370 and non-volatile storage drive 1380 (e.g., disk drive, optical drive, solid state drive), which are forms of tangible computer-readable memory.

Computer-program product 1305 may be stored in non-volatile storage drive 1380 or another computer-readable medium accessible to computer 1202 and loaded into memory 1370. Each processor 1360 may comprise a microprocessor, such as a microprocessor from Intel® or Advanced Micro Devices, Inc.®, or the like. To support computer-program product 1305, the computer 1202 runs an operating system that handles the communications of product 1305 with the above-noted components, as well as the communications between the above-noted components in support of the computer-program product 1305. Exemplary operating systems include Windows® or the like from Microsoft® Corporation, Solaris® from Oracle®, LINUX, UNIX, and the like.

User input devices 1340 include all possible types of devices and mechanisms to input information to computer system 1202. These may include a keyboard, a keypad, a mouse, a scanner, a digital drawing pad, a touch screen incorporated into the display, audio input devices such as voice recognition systems, microphones, and other types of input devices. In various embodiments, user input devices 1340 are typically embodied as a computer mouse, a trackball, a track pad, a joystick, wireless remote, a drawing tablet, a voice command system. User input devices 1340 typically allow a user to select objects, icons, text and the like that appear on the monitor 1206 via a command such as a click of a button or the like. User output devices 1330 include all possible types of devices and mechanisms to output information from computer 1202. These may include a display (e.g., monitor 1206), printers, non-visual displays such as audio output devices, etc.

Communications interface 1350 provides an interface to other communication networks 1395 and devices and may serve as an interface to receive data from and transmit data to other systems, WANs and/or the Internet 1218. Embodiments of communications interface 1350 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1350 may be coupled to a computer network, to a FireWire® bus, or the like. In other embodiments, communications interface 1350 may be physically integrated on the motherboard of computer 1202, and/or may be a software program, or the like.

RAM 1370 and non-volatile storage drive 1380 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1370 and non-volatile storage drive 1380 may be configured to store the basic programming and data constructs that provide the functionality of various embodiments of the present invention, as described above.

Software instruction sets that provide the functionality of the present invention may be stored in RAM 1370 and non-volatile storage drive 1380. These instruction sets or code may be executed by the processor(s) 1360. RAM 1370 and non-volatile storage drive 1380 may also provide a repository to store data and data structures used in accordance with the present invention. RAM 1370 and non-volatile storage drive 1380 may include a number of memories including a main random access memory (RAM) to store of instructions and data during program execution and a read-only memory (ROM) in which fixed instructions are stored. RAM 1370 and non-volatile storage drive 1380 may include a file storage subsystem providing persistent (non-volatile) storage of program and/or data files. RAM 1370 and non-volatile storage drive 1380 may also include removable storage systems, such as removable flash memory.

Bus subsystem 1390 provides a mechanism to allow the various components and subsystems of computer 1202 communicate with each other as intended. Although bus subsystem 1390 is shown schematically as a single bus, alternative embodiments of the bus subsystem may utilize multiple busses or communication paths within the computer 1202.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A non-transitory computer-readable storage medium having stored thereon instructions for facilitating a supplier information handling system, which instructions, when executed by one or more processors, cause the one or more processors to:
recognize a trigger event corresponding to a requested change in a supplier relationship status for a prospective supplier;
responsive to the trigger event, process a supplier profile corresponding to the prospective supplier to identify missing profile information;
launch a workflow to collect the missing profile information from the prospective supplier;
collect the missing profile information from the prospective supplier; and
responsive to an approval of changes to the supplier profile based on the missing profile information, launch a spend authorization workflow to promote the supplier relationship status.

2. The non-transitory computer-readable storage medium of claim 1, wherein the trigger event corresponding to the prospective supplier further corresponds to one or more of a sourcing award action, an intervention by the buyer, a registration by the supplier, and/or a request by the supplier.

3. The non-transitory computer-readable storage medium of claim 1, wherein the instructions further cause the one or more processors to:
process a supplier profile definition that identifies required profile information;
wherein the processing the supplier profile corresponding to the prospective supplier to identify missing profile information comprises comparing the supplier profile to the supplier profile definition.

4. The non-transitory computer-readable storage medium of claim 3, wherein the instructions further cause the one or more processors to:
configure a buyer interface to allow customization of the supplier profile definition; and
process a first customization of the supplier profile definition;
wherein the processing the supplier profile corresponding to the prospective supplier to identify missing profile information is based at least in part on the first customization of the supplier profile definition.

5. The non-transitory computer-readable storage medium of claim 1, wherein the instructions further cause the one or more processors to:
trigger a notification to the prospective supplier, wherein the notification to the prospective supplier comprises a navigational reference to direct the supplier to complete the supplier profile.

6. The non-transitory computer-readable storage medium of claim 1, wherein the launching the workflow to collect the missing profile information from the prospective supplier comprises initiating profile completion page flow that identifies missing profile information.

7. The non-transitory computer-readable storage medium of claim 1, wherein the instructions further cause the one or more processors to:
process a change request based at least partially on the collecting the missing profile information from the prospective supplier;
trigger a notification to the buyer, based at least partially on the processing the change request; and
configure a review interface to allow review of the change request.

8. A method for supplier relationship management, the method comprising:
recognizing a trigger event corresponding to a requested change in a supplier relationship status for a prospective supplier;
responsive to the trigger event, processing a supplier profile corresponding to the prospective supplier to identify missing profile information;
launching a workflow to collect the missing profile information from the prospective supplier;
collecting the missing profile information from the prospective supplier; and
responsive to an approval of changes to the supplier profile based on the missing profile information, launching a spend authorization workflow to promote the supplier relationship status.

9. The method of claim 8, wherein the trigger event corresponding to the prospective supplier further corresponds to one or more of a sourcing award action, an intervention by the buyer, a registration by the supplier, and/or a request by the supplier.

10. The method of claim 8, further comprising:
processing a supplier profile definition that identifies required profile information;
wherein the processing the supplier profile corresponding to the prospective supplier to identify missing profile information comprises comparing the supplier profile to the supplier profile definition.

11. The method of claim 10, further comprising:
configuring a buyer interface to allow customization of the supplier profile definition; and
processing a first customization of the supplier profile definition;
wherein the processing the supplier profile corresponding to the prospective supplier to identify missing profile information is based at least in part on the first customization of the supplier profile definition.

12. The method of claim 8, further comprising:
triggering a notification to the prospective supplier, wherein the notification to the prospective supplier comprises a navigational reference to direct the supplier to complete the supplier profile.

13. The method of claim 8, wherein the launching the workflow to collect the missing profile information from the prospective supplier comprises initiating profile completion page flow that identifies missing profile information.

14. The method of claim 8, further comprising:
processing a change request based at least partially on the collecting the missing profile information from the prospective supplier;
triggering a notification to the buyer, based at least partially on the processing the change request; and
configuring a review interface to allow review of the change request.

15. A supplier relationship management system, comprising:
one or more network interfaces configured to provide access to a network;
one or more processors coupled to the one or more network interfaces to execute instructions to:
recognize a trigger event corresponding to a requested change in a supplier relationship status for a prospective supplier;
responsive to the trigger event, process a supplier profile corresponding to the prospective supplier to identify missing profile information;
launch a workflow to collect the missing profile information from the prospective supplier;
collect the missing profile information from the prospective supplier; and
responsive to an approval of changes to the supplier profile based on the missing profile information, launch a spend authorization workflow to promote the supplier relationship status; and
one or more storage media coupled to the one or more processors to retain the instructions.

16. The supplier relationship management system of claim 15, wherein the trigger event corresponding to the prospective supplier further corresponds to one or more of a sourcing award action, an intervention by the buyer, a registration by the supplier, and/or a request by the supplier.

17. The supplier relationship management system of claim 15, wherein the one or more processors are to further execute instructions to:
process a supplier profile definition that identifies required profile information;
wherein the processing the supplier profile corresponding to the prospective supplier to identify missing profile information comprises comparing the supplier profile to the supplier profile definition.

18. The supplier relationship management system of claim 17, wherein the one or more processors are to further execute instructions to:
configure a buyer interface to allow customization of the supplier profile definition; and
process a first customization of the supplier profile definition;
wherein the processing the supplier profile corresponding to the prospective supplier to identify missing profile information is based at least in part on the first customization of the supplier profile definition.

19. The supplier relationship management system of claim 15, wherein the one or more processors are to further execute instructions to:
trigger a notification to the prospective supplier, wherein the notification to the prospective supplier comprises a navigational reference to direct the supplier to complete the supplier profile.

20. The supplier relationship management system of claim 15, wherein the launching the workflow to collect the missing profile information from the prospective supplier comprises initiating profile completion page flow that identifies missing profile information.
